(19) United States
(12) Patent Application Publication
(10) Pub. No.: US 2011/0304660 A1
(43) Pub. Date: Dec. 15, 2011

(54) DISPLAY DEVICE DRIVING METHOD AND DISPLAY DEVICE

(75) Inventors: Yen-Tao LIAO, Hsin-Chu (TW); Sheng-Wen CHENG, Hsin-Chu (TW)

(73) Assignee: AU OPTRONICS CORP., HSINCHU (TW)

(21) Appl. No.: 12/915,933

(22) Filed: Oct. 29, 2010

(30) Foreign Application Priority Data
Jun. 14, 2010 (TW) 099119343

(51) Int. Cl. G09G 5/02

(52) U.S. Cl. 345/694

(57) ABSTRACT

An exemplary display device driving method is applied to a display device. The display device includes a pixel array and a data driving circuit. The pixel array has first through fourth pixels. Each of the first through fourth pixels includes first through fourth sub-pixels. In the display device driving method, each of the first through fourth pixels is provided with a data signal. At least one colored sub-pixel is enabled to display a second gray level in turns in multiple frames of a same frequency period, and the remained sub-pixels are enabled to display a first gray level smaller than the second gray level.

### BACKGROUND

1. Technical Field

The present invention generally relates to display fields and, particularly to a display device driving method and a display device.

2. Description of the Related Art

Nowadays, liquid crystal display devices can use frame rate control to increase the number of gray levels. The frame rate control can use time or space to achieve desired display effects, where the approach of using time to generate the frame rate control effect generally is termed as temporal dithering method and the approaching of using space to generate frame rate control effect is termed as spatial dithering method.

In the spatial dithering method, multiple sub-pixels in each of multiple frames in one second are enabled to display different gray levels, so as to simulate an intermediate gray level. For example, in each frame, one-fourth number of sub-pixels are enabled to display a gray level of (A+1), and the remained three-fourth number of sub-pixels are enabled to display another gray level of A, so that an intermediate gray level of (A+1/4) can be achieved. In other words, much more number of gray levels can be achieved by the spatial dithering method based on less available number of gray levels.

Referring to FIGS. 1A-1D, showing schematic views of image frame rate control in a conventional display device. FIGS. 1A-1D each shows a matrix pattern usually used in a four-colored liquid crystal display device. A size of the matrix pattern generally is a multiple of the types of colored sub-pixels (e.g., red, green, blue and white types of colored sub-pixels). FIGS. 1A-1D respectively are schematic views of four frames in a same frequency period. Each frame is consisted of sixteen pixels, and each pixel (e.g., P1) includes a red sub-pixel R, a green sub-pixel G, a blue sub-pixel B and a white sub-pixel W.

In FIG. 1A, in regard of pixels P1-P4 in the frame F0, the red sub-pixels R and green sub-pixels G of the pixels P1, P2 are enabled to display the gray level of (A+1), and the blue sub-pixels B and white sub-pixels W of the pixels P1, P2 are enabled to display the gray level of A. The red sub-pixels R and green sub-pixels G of the pixels P3, P4 are enabled to display the gray level of A, and the blue sub-pixels B and white sub-pixels W are enabled to display the gray level of (A+1). Where, the subscript “2” of the sub-pixels in FIG. 1A represents the gray level of (A+1), and the subscript “1” of the sub-pixels in FIG. 1A represents the gray level of A.

In FIG. 1B, in regard of the pixels P1-P4 in the frame F1, the red sub-pixels R and blue sub-pixels B of the pixels P1, P3 are enabled to display the gray level of (A+1), and the green sub-pixels G and white sub-pixels W of the pixels P1, P3 are enabled to display the gray level of A. The red sub-pixels R and blue sub-pixels B of the pixels P2, P4 are enabled to display the gray level of A, and the green sub-pixels G and white sub-pixels W of the pixels P2, P4 are enabled to display the gray level of (A+1).

In FIG. 1C, in regard of the pixels P1-P4 in the frame F2, the red sub-pixels R and white sub-pixels W of the pixels P1, P2 are enabled to display the gray level of (A+1), and the green sub-pixels G and blue sub-pixels B of the pixels P1, P2 are enabled to display the gray level of A. The red sub-pixels R and white sub-pixels W of the pixels P3, P4 are enabled to display the gray level of A, and the green sub-pixels G and blue sub-pixels B of the pixels P3, P4 are enabled to display the gray level of (A+1).

In FIG. 1D, in regard of the pixels P1-P4 in the frame F3, the red sub-pixels R and blue sub-pixels B of the pixels P1, P3 are enabled to display the gray level of A, and the green sub-pixels G and white sub-pixels W of the pixels P1, P3 are enabled to display the gray level of (A+1). The red sub-pixels R and blue sub-pixels B of the pixels P2, P4 are enabled to display the gray level of (A+1), and the green sub-pixels G and white sub-pixels W of the pixels P2, P4 are enabled to display the gray level of A.

For the illustration of FIGS. 1A and 1B, the distribution of the gray levels of (A+1) and A would easily cause the occurrence of horizontal line mura in displayed images. For the illustration of FIGS. 1C and 1D, the distribution of the gray levels of (A+1) and A would easily cause the occurrence of vertical line mura in displayed images.

### BRIEF SUMMARY

Accordingly, the present invention is directed to a display device driving method, which can avoid the occurrence of pattern mura in displayed images.

The present invention is further directed to a display device, which facilitates the sub-pixels displaying a second gray level in each frame to have a uniform arrangement.

More specifically, a display device driving method in accordance with an embodiment of the present invention is adapted to a display device. Herein, the display device includes a pixel array. The pixel array has a first pixel, a second pixel, a third pixel and a fourth pixel. The first pixel is arranged neighboring with the second and third pixels, and the fourth pixel is arranged neighboring with the second and third pixels. Each of the first through fourth pixels includes a first sub-pixel, a second sub-pixel, a third sub-pixel and a fourth sub-pixel, and each of the first through fourth sub-pixels has a corresponding color. In the display device driving method, each of the first through fourth pixels is provided with a data signal. In a first frame of a frequency period, the second and third sub-pixels of each of the first through fourth pixels are enabled to display first gray levels for the second and third sub-pixels, and the first sub-pixel of each of the first through fourth pixels is enabled to display a second gray level. In a second frame of the frequency period, the first and fourth sub-pixels of each of the first through fourth pixels are enabled to display the first gray levels for the first and fourth sub-pixels, and the second sub-pixel of each of the first through fourth pixels is enabled to display the second gray level. In a third frame of the frequency period, the second and third sub-pixels of each of the first through fourth pixels are enabled to display the first gray levels for the second and third sub-pixels, and the fourth sub-pixel of each of the first through fourth pixels is enabled to display the second gray level. In a fourth frame of the frequency period, the first and fourth sub-pixels of each of the first through fourth pixels are enabled to display the first gray levels for the first and fourth sub-pixels, and the third sub-pixel of each of the first through fourth pixels is enabled to display the second gray level. Moreover, the first sub-pixel is arranged neighboring with the second and third sub-pixels in each of the first through fourth pixels, the fourth sub-pixel is arranged neighboring with the second and third sub-pixels in each of the first through fourth pixels, and the second gray level is greater than the first gray level.

In one embodiment, in the first frame, the fourth sub-pixel of each of the first through fourth pixels is enabled to display the second gray level.

In one embodiment, in the second frame, the third sub-pixel of each of the first through fourth pixels is enabled to display the second gray level.

In one embodiment, in the third frame, the first sub-pixel of each of the first through fourth pixels is enabled to display the second gray level.

In one embodiment, in the fourth frame, the second sub-pixel of each of the first through fourth pixels is enabled to display the second gray level.

In one embodiment, in the above-mentioned display device driving method, each of the first through fourth pixels is further provided with a common voltage. Moreover, in the first through fourth pixels, the sub-pixels having a same corresponding color in the first and second pixels are enabled to have different polarities, the sub-pixels having a same corresponding color in the first and third pixels are enabled to have different polarities, and the sub-pixels having a same corresponding color in the first and fourth pixels are enabled to have a same polarity.

In one embodiment, the first through fourth sub-pixels are arranged with a same manner in the first through fourth pixels according to the respective corresponding colors.

A display device in accordance with another embodiment of the present invention includes a pixel array and a data driving circuit. The pixel array has a first pixel, a second pixel, a third pixel and a fourth pixel. The first pixel is arranged neighboring with the second and third pixels. The fourth pixel is arranged neighboring with the second and third pixels. Each of the first through fourth pixels includes a first sub-pixel, a second sub-pixel, a third sub-pixel and a fourth sub-pixel, and each of the first through fourth sub-pixels has a corresponding color. The data driving circuit is electrically coupled to the pixel array. The data driving circuit is for providing each of the first through fourth pixels with a data signal. The data driving circuit is further for: in a first frame of a frequency period, enabling the second and third sub-pixels of each of the first through fourth pixels to display first gray levels for the second and third sub-pixels and enabling the first sub-pixel of each of the first through fourth pixels to display a second gray level; in a second frame of the frequency period, enabling the first and fourth sub-pixels of each of the first through fourth pixels to display the first gray levels for the first and fourth sub-pixels and enabling the second sub-pixel of each of the first through fourth pixels to display the second gray level; in a third frame of the frequency period, enabling the second and third sub-pixels of each of the first through fourth pixels to display the first gray levels for the second and third sub-pixels and enabling the fourth sub-pixel of each of the first through fourth pixels to display the second gray level; and in a fourth frame of the frequency period, enabling the first and fourth sub-pixels of each of the first through fourth pixels to display the first gray levels for the first and fourth sub-pixels and enabling the third sub-pixel of each of the first through fourth pixels to display the second gray level. The first sub-pixel is arranged neighboring with the second and third sub-pixels, the fourth sub-pixel is arranged neighboring with the second and third sub-pixels, and the second gray level is greater than the first gray level.

In the various embodiments of the present invention, at least one colored sub-pixel is enabled to display the second gray level in turns in multiple frames of a same frequency period, while the remained sub-pixel are enabled to display the first gray level. Accordingly, the amount of the sub-pixels for displaying the higher gray level with same color in a single frame can be increased, and the pattern mura associated with the prior art can be effectively suppressed owning to the particular arrangement of the sub-pixels for displaying the higher gray level.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIGS. 1A-1D show schematic views of image frame rate control in a conventional display device.

FIG. 2 shows a circuit block diagram of a display device in accordance with an embodiment of the present invention.

FIGS. 3A-3D show schematic views of image frame rate control in accordance with an embodiment of the present invention.

FIG. 4 shows a step flow chart of a display device driving method in accordance with an embodiment of the present invention.

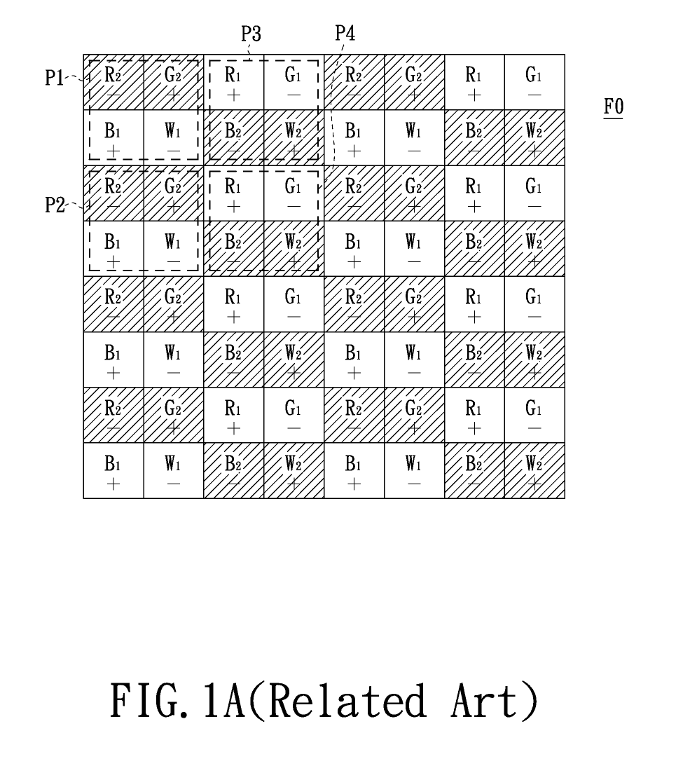

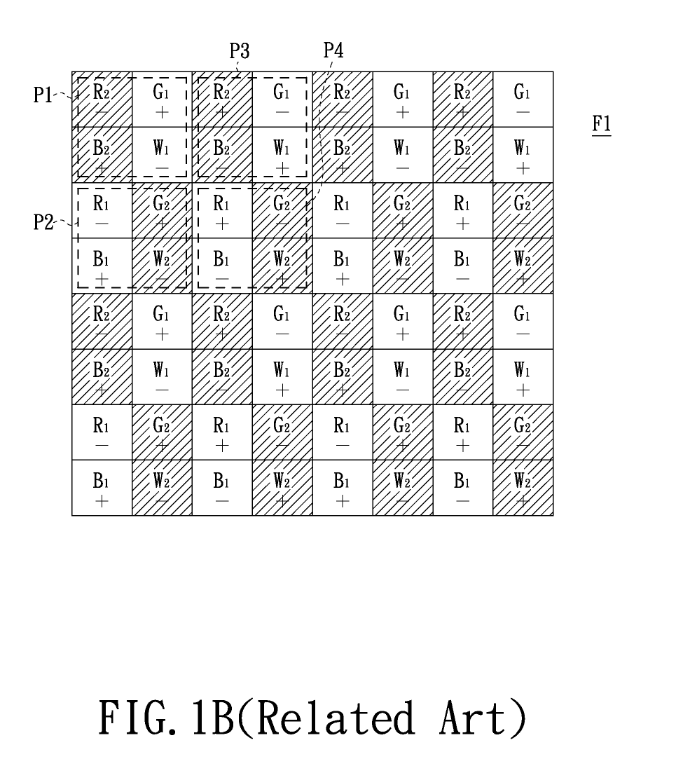

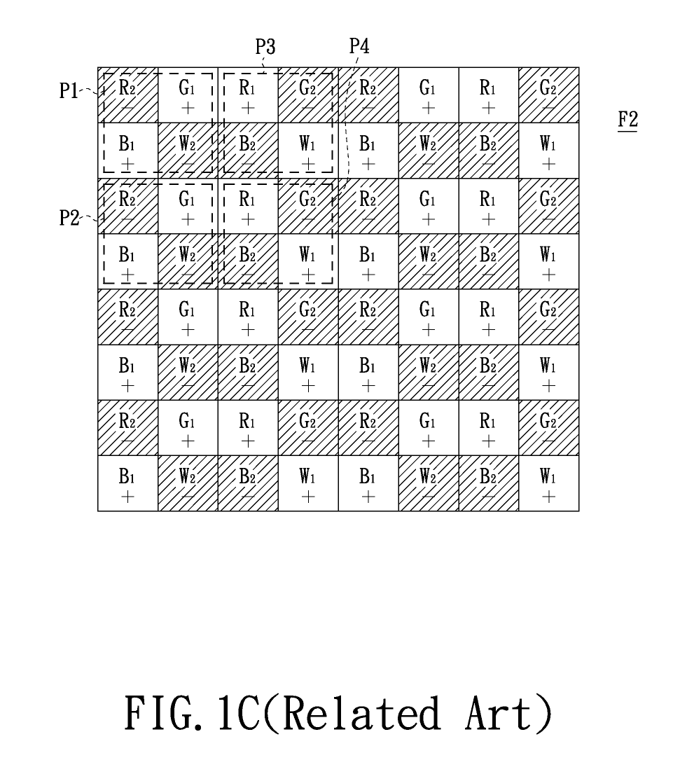

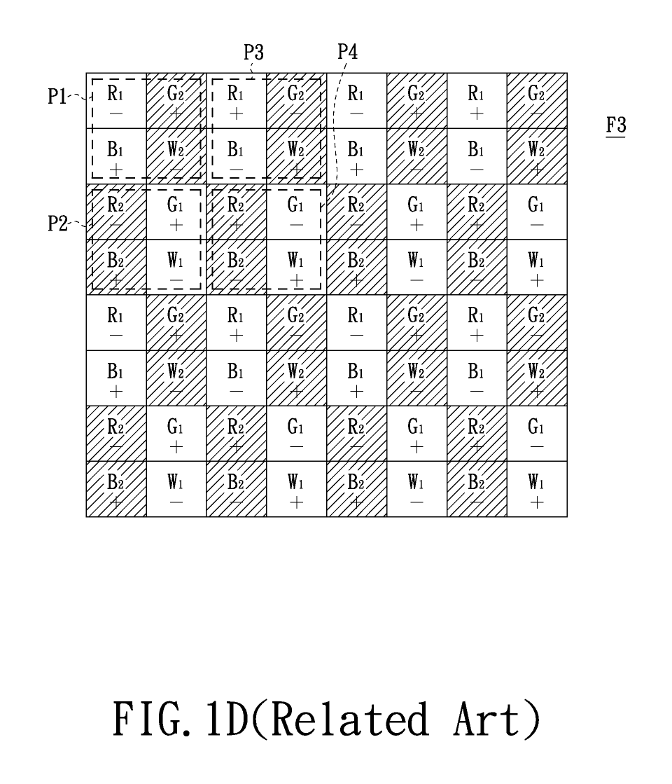

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. Accordingly, the descriptions will be regarded as illustrative in nature and not as restrictive.

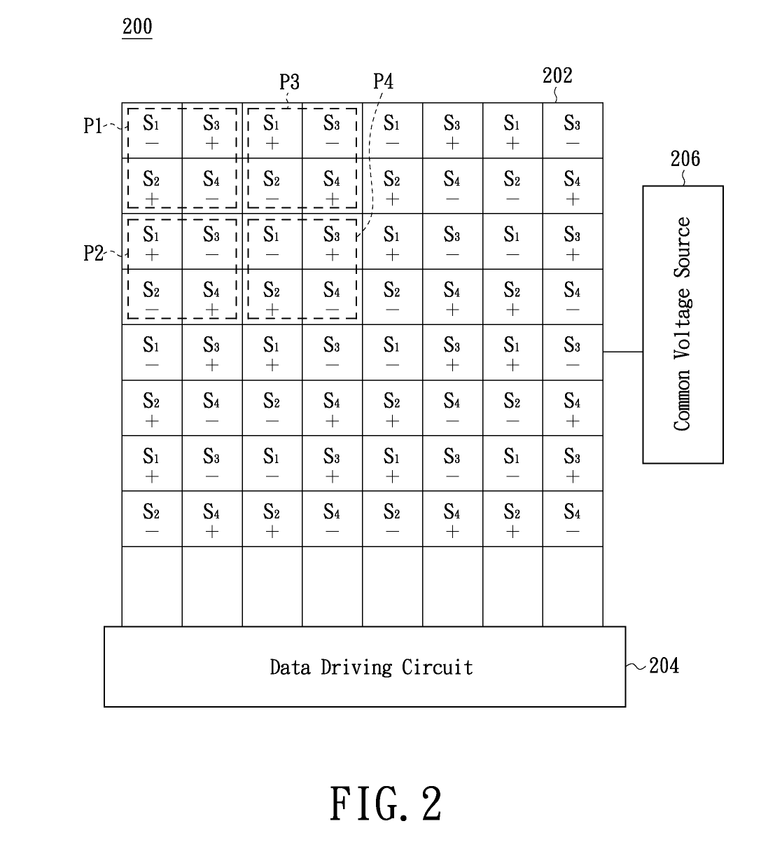

Referring to FIG. 2, showing a circuit block diagram of a display device in accordance with an embodiment of the present invention. In the illustrated embodiment, the display device 200 includes a pixel array 202, a data driving circuit 204 and a common voltage source 206. The pixel array 202 is electrically coupled to the data driving circuit 204 and the common voltage source 206. The data driving circuit 204 is for providing the pixel array 202 with data signals. The common voltage source 206 is for supplying a common voltage to the pixel array 202.

In FIG. 2, pixels P1, P2, P3 and P4 in the pixel array 202 are taken as an example in the following for the purpose of illustration. The pixel P1 is arranged neighboring with the pixels P2 and P3. The pixel P4 also is arranged neighboring with the pixels P2 and P3. FIG. 2 illustrates sixteen pixels for the purpose of illustration, but it is understood to the skilled person in the art that the amount of pixels is not limited to this.

Each of the pixels P1, P2, P3 and P4 includes sub-pixels S1, S2, S3 and S4. The sub-pixel S1 is arranged neighboring with the sub-pixels S2 and S3. The sub-pixel S4 is arranged neighboring with the sub-pixels S2 and S3. Each of the sub-pixels S1, S2, S3 and S4 generally includes a pixel electrode (not shown) and a common electrode (not shown) opposite to the pixel electrode. The pixel electrode is for receiving the data signal, and the common electrode is for receiving the common voltage.

In the illustrated embodiment, the sub-pixels 51, S2, S3 and S4 are arranged in a same manner in the pixels P1, P2, P3 and P4 according to the respective corresponding colors. The sub-pixels S1, S2, S3 and S4 can respectively be a red (R) sub-pixel, a blue (B) sub-pixel, a green (G) sub-pixel and a white (W) sub-pixel, but the color types and the arrangement manner are not limited to these, for example, they can respectively be a red (R) sub-pixel, a blue (B) sub-pixel, a green (G) sub-pixel and a yellow (Y) sub-pixel instead, which also is within the scope and spirit of the present invention.

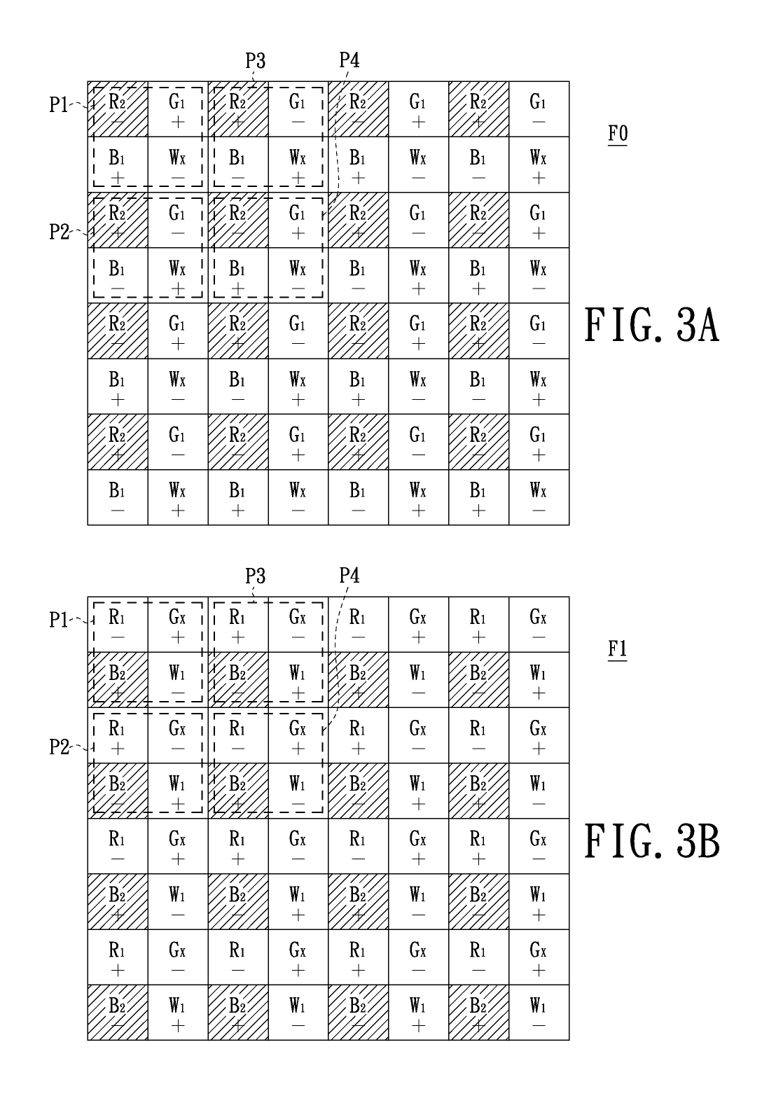

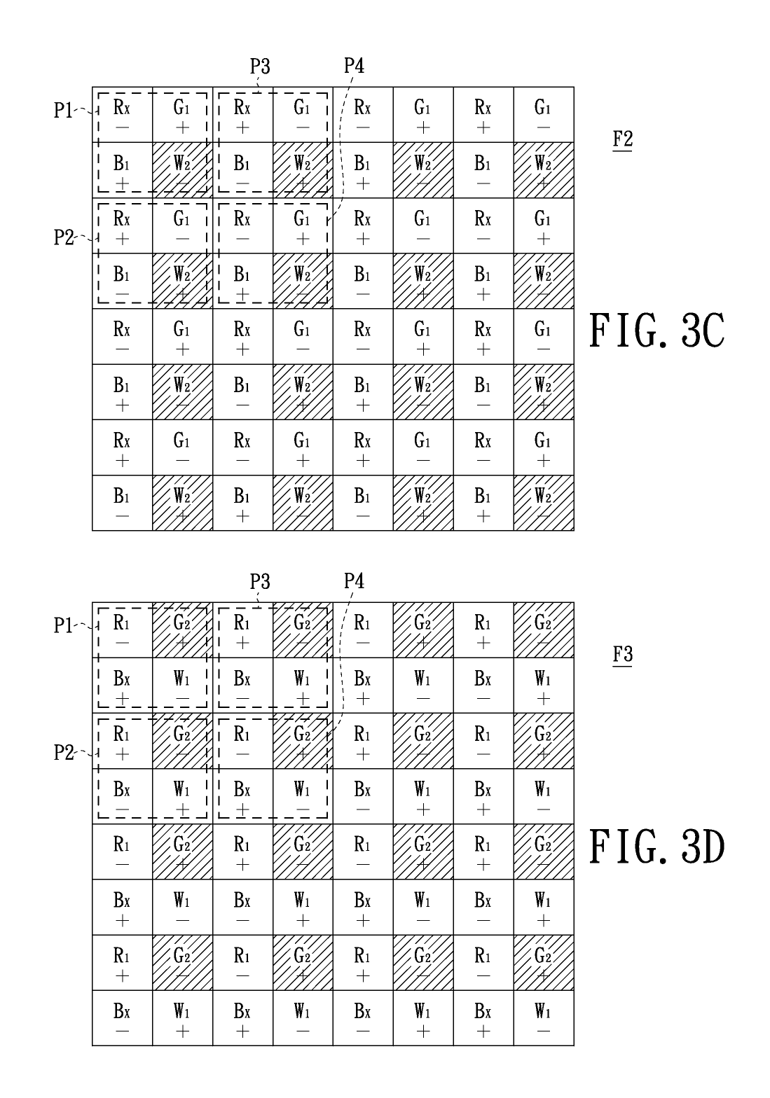

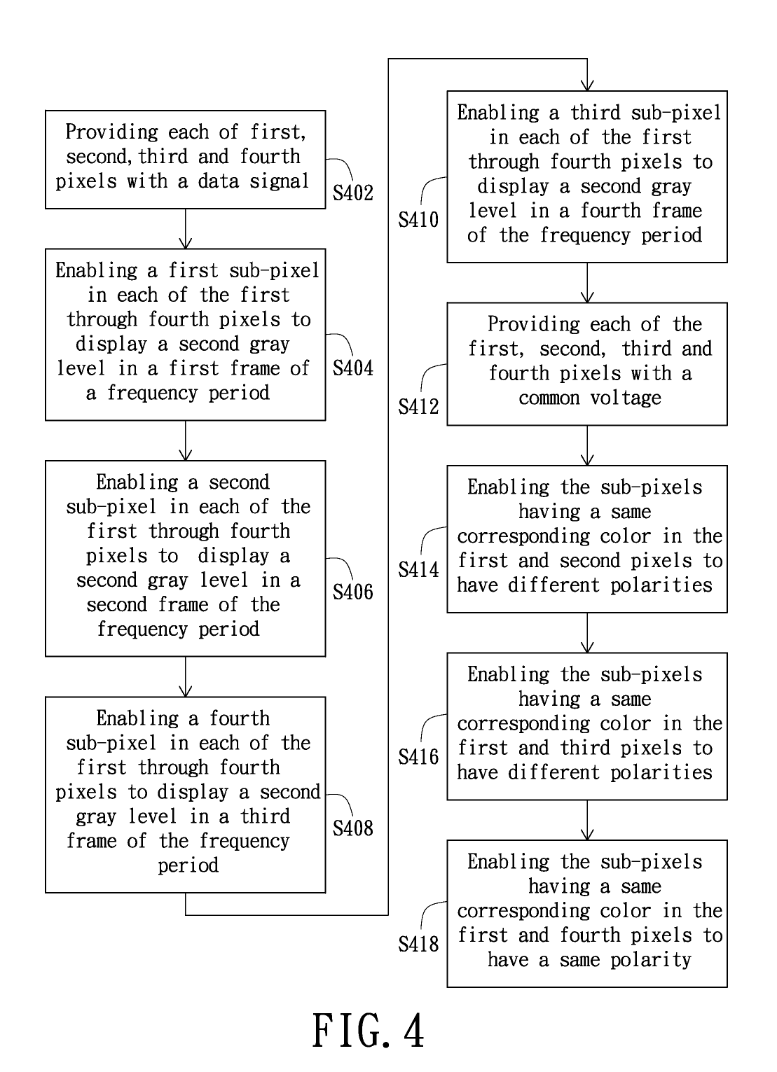

Please refer to FIGS. 3A-3D and FIG. 4 together, FIGS. 3A-3D showing schematic views of image frame rate control in accordance with an embodiment, and FIG. 4 showing a step flow chart of a display device driving method in accordance with the embodiment of the present invention. In this embodiment, sixteen pixels are taken as an example for the purpose of illustration, and each pixel includes, for example a red sub-pixel R, a blue sub-pixel B, a green sub-pixel G and a white sub-pixel W. FIGS. 3A-3D respectively illustrates four frames F0-F3 in a frequency period (e.g., 60 Hz) of the display device, but the amount of the frames in a single frequency period is not limited to this. The reference symbols “+” and “−” represent polarities of the sub-pixels, the subscript “1” represents the sub-pixels displayed with a first gray level, the subscript “2” represents the sub-pixels displayed with a second gray level, and the reference symbol “x” represents the sub-pixels displayed with the first gray level or the second gray level.

In a preferred embodiment, the amount of the sub-pixels with positive polarity (+) is the same as the amount of the sub-pixels with negative polarity (−) in each of the frames F0-F3.

In a preferred embodiment, the second gray level is greater than the first gray level.

After the display device 200 as illustrated in FIG. 2 is booted up, the data driving circuit 204 provides the pixel array 202 with data signals in a same frequency period to enable the data signals to be displayed in the frames F0-F3 (step S402).

In regard of the frame F0 in FIG. 3A, the red sub-pixels R in the pixels P1-P4 are enabled to display the second gray level, the green sub-pixels G and the blue sub-pixels B in the pixels P1-P4 are enabled to display the first gray level, and the white sub-pixels W in the pixels P1-P4 can be enabled to display, for example the first gray level. If wanting to improve the image quality, the white sub-pixels W can be enabled to display the second gray level instead (step S404).

In regard of the frame F1 in FIG. 3B, the red sub-pixels R and the white sub-pixels W in the pixels P1-P4 are enabled to display the first gray level, the blue sub-pixels B in the pixels P1-P4 are enabled to display the second gray level, and the green sub-pixels G in the pixels P1-P4 can be enabled to display, for example the first gray level. If wanting to improve the image quality, the green sub-pixels G can be enabled to display the second gray level instead (step S406).

In regard of the frame F2 in FIG. 3C, the white sub-pixels W in the pixels P1-P4 are enabled to display the second gray level, the blue sub-pixels B and the green sub-pixels G in the pixels P1-P4 are enabled to display the first gray level, and the red sub-pixels R in the pixels P1-P4 can be enabled to display, for example the first gray level. If wanting to improve the image quality, the red sub-pixels R can be enabled to display the second gray level instead (step S408).

In regard of the frame F3 in FIG. 3D, the green sub-pixels G in the pixels P1-P4 are enabled to display the second gray level, the red sub-pixels R and the white sub-pixels W in the pixels P1-P4 are enabled to display the first gray level, and the blue sub-pixels B in the pixels P1-P4 can be enabled to display the first gray level. If wanting to improve the image quality, the blue sub-pixels B can be enabled to display the second gray level instead (step S410).

In a preferred embodiment of the present invention, in order to achieve the purpose of the amounts of the sub-pixels displayed with the respective colors and same gray level in the frames F0-F3 being the same, when the red sub-pixels R and the white sub-pixels W in the frame F0 are enabled to display the second gray levels, the red sub-pixels R and the white sub-pixels W in the frame F2 ought to be enabled to display the second gray level. Likewise, the blue sub-pixels B and the green sub-pixels G in the frame F1 ought to be enabled to display the second gray level, the blue sub-pixels B and the green sub-pixels G in the frame F3 ought to be enabled to display the second gray level.

In the illustrated embodiment, during providing the data signals to the pixel array 202 in FIG. 2, the common voltage source 206 provides a common voltage to each sub-pixel of the pixel array 202 (step S412). In addition, for the convenience of description, the step S402 and the step S412 in this embodiment are described separately, but the data signals and the common voltage can be provided simultaneously.

In regard of the frames F0-F3 of FIGS. 3A-3D, the common voltage provided to the pixels P1-P4 makes the red sub-pixels R and the white sub-pixels W in the pixel P1 to have the negative polarity (−), the green sub-pixels G and the blue sub-pixels B to have the positive polarity (+), and further makes the red sub-pixels R and the white sub-pixels W in the pixel P2 to have the positive polarity (+), and the green sub-pixels G and the blue sub-pixels B to have the negative polarity (−) (step S414).

Moreover, the common voltage provided to the pixels P1-P4 makes the red sub-pixels R and the white sub-pixels W in the pixel P1 to have the negative polarity (−), the green sub-pixels G and the blue sub-pixels B to have the positive polarity (+), and further makes the red sub-pixels R and the white sub-pixels W in the pixel P3 to have the positive polarity (+), and the green sub-pixels G and the blue sub-pixels B to have the negative polarity (−) (step S416).

Furthermore, the common voltage provided to the pixels P1-P4 makes the red sub-pixels R and the white sub-pixels W in the pixel P1 to have the negative polarity (−), the green sub-pixels G and the blue sub-pixels B to have the positive polarity (+), and further makes the red sub-pixels R and the white sub-pixels W in the pixel P4 to have the negative polarity (−), and the green sub-pixels G and the blue sub-pixels B to have the positive polarity (+) (step S418).

In short, as illustrated in FIG. 4, the display device driving method in accordance with the embodiment of the present invention can include the following steps of: providing the first, second, third and fourth pixels each with a data signal (S402); enabling a first sub-pixel in each of the first through fourth pixels to display a second gray level in a first frame (S404); enabling a second sub-pixel in each of the first through fourth pixels to display the second gray level in a second frame (S406); enabling a fourth sub-pixel in each of the first through fourth pixels to display the second gray level in a third frame (S408); enabling a third sub-pixel in each of the first through fourth pixels to display the second gray level in a fourth frame (S410); providing a common voltage to each of the first, second, third and fourth pixels (S412); enabling the sub-pixels having a same corresponding color in the first and second pixels to have different polarities (S414); enabling the sub-pixels having a same corresponding color in the first and third pixels to have different polarities (S416); and enabling the sub-pixels having a same corresponding color in the first and fourth pixels to have a same polarity (S418). It is understood that, the order of the steps S402-S418 in the display device driving method in accordance with the embodiment can be suitably modified, the modification also is within the scope and spirit of the present invention.

In summary, In the various embodiments of the present invention, at least one colored sub-pixel is enabled to display the second gray level in turns in multiple frames of a same frequency period, while the remained sub-pixel are enabled to display the first gray level. Accordingly, the amount of the sub-pixels for displaying the higher gray level with same color in a single frame can be increased, and the pattern mura associated with the prior art can be effectively suppressed owning to the particular arrangement of the sub-pixels for displaying the higher gray level.

Additionally, the skilled person in the art can make some suitable modification(s) to the display device and the display device driving method in accordance with the above embodiments, for example, suitably changing the amount of types of the colored sub-pixels (e.g., more than four types of colored sub-pixels) in each pixel, suitably changing the display order of the frames shown in FIGS. 3A-3d, and/or suitably changing the polarities of the sub-pixels in the display device driving method, and so on, as long as it can achieve the purpose of improving the display image quality.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A display device driving method adapted to a display device, the display device comprising a pixel array, the pixel array having a first pixel, a second pixel, a third pixel and a fourth pixel, the first pixel being arranged neighboring with the second and third pixels, the fourth pixel being arranged neighboring with the second and third pixels, each of the first through fourth pixels comprising a first sub-pixel, a second sub-pixel, a third sub-pixel and a fourth sub-pixel, each of the first through fourth sub-pixels having a corresponding color; the display device driving method comprising:
providing each of the first through fourth pixels with a data signal;
in a first frame of a frequency period, enabling the second and third sub-pixels of each of the first through fourth pixels to display first gray levels for the second and third sub-pixels and enabling the first sub-pixel of each of the first through fourth pixels to display a second gray level;
in a second frame of the frequency period, enabling the first and fourth sub-pixels of each of the first through fourth pixels to display the first gray levels for the first and forth sub-pixels and enabling the second sub-pixel of each of the first through fourth pixels to display the second gray level;
in a third frame of the frequency period, enabling the second and third sub-pixels of each of the first through fourth pixels to display the first gray levels for the second and third sub-pixels and enabling the fourth sub-pixel of each of the first through fourth pixels to display the second gray level; and
in a fourth frame of the frequency period, enabling the first and fourth sub-pixels of each of the first through fourth pixels to display the first gray levels for the first and forth sub-pixels and enabling the third sub-pixel of each of the first through fourth pixels to display the second gray level;
wherein the first sub-pixel is arranged neighboring with the second and third sub-pixels in each of the first through fourth pixels, the fourth sub-pixel is arranged neighboring with the second and third sub-pixels in each of the first through fourth pixels, and the second gray level is greater than the first gray level.

2. The display device driving method as claimed in claim 1, wherein in the first frame, the fourth sub-pixel of each of the first through fourth pixels is enabled to display the second gray level.

3. The display device driving method as claimed in claim 2, wherein in the second frame, the third sub-pixel of each of the first through fourth pixels is enabled to display the second gray level.

4. The display device driving method as claimed in claim 3, wherein in the third frame, the first sub-pixel of each of the first through fourth pixels is enabled to display the second gray level.

5. The display device driving method as claimed in claim 4, wherein in the fourth frame, the second sub-pixel of each of the first through fourth pixels is enabled to display the second gray level.

6. The display device driving method as claimed in claim 1, further comprising:
providing each of the first through fourth pixels with a common voltage.

7. The display device driving method as claimed in claim 6, further comprising:
in the first through fourth frames, enabling the sub-pixels having a same corresponding color in the first and second pixels to have different polarities.

8. The display device driving method as claimed in claim 7, further comprising:
in the first through fourth frames, enabling the sub-pixels having a same corresponding color in the first and third pixels to have different polarities.

9. The display device driving method as claimed in claim 8, further comprising:
in the first through fourth frames, enabling the sub-pixels having a same corresponding color in the first and fourth pixels to have a same polarity.

10. The display device driving method as claimed in claim 1, wherein the first through fourth sub-pixels are arranged with a same manner in the first through fourth pixels according to the respective corresponding colors.

11. A display device comprising:
a pixel array comprising a first pixel, a second pixel, a third pixel and a fourth pixel, the first pixel being arranged neighboring with the second and third pixels, the fourth pixel being arranged neighboring with the second and third pixels, each of the first through fourth pixels comprising a first sub-pixel, a second sub-pixel, a third sub-pixel and a fourth sub-pixel, each of the first through fourth sub-pixels having a corresponding color; and
a data driving circuit electrically coupled to the pixel array;
wherein the data driving circuit is for providing each of the first through fourth pixels with a data signal and further for:
in a first frame of a frequency period, enabling the second and third sub-pixels of each of the first through fourth pixels to display first gray levels for the second and third sub-pixels and enabling the first sub-pixel of each of the first through fourth pixels to display a second gray level,
in a second frame of the frequency period, enabling the first and fourth sub-pixels of each of the first through fourth pixels to display the first gray levels for the first and forth sub-pixels and enabling the second sub-pixel of each of the first through fourth pixels to display the second gray level,
in a third frame of the frequency period, enabling the second and third sub-pixels of each of the first through fourth pixels to display the first gray levels for the second and third sub-pixels and enabling the fourth sub-pixel of each of the first through fourth pixels to display the second gray level,
in a fourth frame of the frequency period, enabling the first and fourth sub-pixels of each of the first through fourth pixels to display the first gray levels for the first and forth sub-pixels and enabling the third sub-pixel of each of the first through fourth pixels to display the second gray level,
wherein the first sub-pixel is arranged neighboring with the second and third sub-pixels in each of the first through fourth pixels, the fourth sub-pixel is arranged neighboring with the second and third sub-pixels in each of the first through fourth pixels, and the second gray level is greater than the first gray level.

12. The display device as claimed in claim 11, wherein in the first frame, the fourth sub-pixel of each of the first through fourth pixels is enabled by the data driving circuit to display the second gray level.

13. The display device as claimed in claim 12, wherein in the second frame, the third sub-pixel of each of the first through fourth pixels is enabled by the data driving circuit to display the second gray level.

14. The display device as claimed in claim 13, wherein in the third frame, the first sub-pixel of each of the first through fourth pixels is enabled by the data driving circuit to display the second gray level.

15. The display device as claimed in claim 14, wherein in the fourth frame, the second sub-pixel of each of the first through fourth pixels is enabled by the data driving circuit to display the second gray level.

16. The display device as claimed in claim 11, wherein in the first through fourth frames, the sub-pixels with a same corresponding color in the first and second pixels are enabled by the data driving circuit to have different polarities.

17. The display device as claimed in claim 16, wherein in the first through fourth frames, the sub-pixels with a same corresponding color in the first and third pixels are enabled by the data driving circuit to have different polarities.

18. The display device as claimed in claim 17, wherein in the first through fourth frames, the sub-pixels with a same corresponding color in the first and fourth pixels are enabled by the data driving circuit to have a same polarity.

19. The display device as claimed in claim 11, wherein the first through fourth sub-pixels are arranged with a same manner in the first through fourth pixels according to the respective corresponding colors.
